(19) United States
(12) Patent Application Publication
(10) Pub. No.: US 2025/0108793 A1
(43) Pub. Date: Apr. 3, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Yoshihiro Oniwa, Tokyo (JP)

(21) Appl. No.: 18/894,416

(22) Filed: Sep. 24, 2024

(30) Foreign Application Priority Data
Sep. 29, 2023 (JP) 2023-168951

(51) Int. Cl. B60W 30/09; B60W 50/14

(52) U.S. Cl. CPC B60W 30/09; B60W 50/14; B60W 2540/18; B60W 2710/20; B60W 2720/106

(57) ABSTRACT

A vehicle control device according to an embodiment includes a recognizer that recognizes a surrounding situation of a vehicle, a vehicle controller that executes vehicle control for controlling at least one of acceleration/deceleration and steering of the vehicle, and a driving state detector that detects a driving state of an occupant. The vehicle control includes alarm control for notifying the occupant when the vehicle approaches an obstacle, and avoidance control for avoiding contact with the obstacle when the vehicle has approached further toward the obstacle from in the alarm control. The alarm control is suspended when a steering operation equal to or more than a predetermined amount is detected due to a steering operation of the occupant during the alarm control. The avoidance control is not suspended when a steering operation equal to or more than a predetermined amount is detected during the avoidance control.

### CROSS-REFERENCE TO RELATED APPLICATION

Priority is claimed on Japanese Patent Application No. 2023-168951, filed Sep. 29, 2023, the content of which is incorporated herein by reference.

### BACKGROUND

### Field of the Invention

The present invention relates to a vehicle control device, a vehicle control method, and a storage medium.

### Description of Related Art

In recent years, efforts to provide access to sustainable transportation systems taking vulnerable people among traffic participants into account have become active. In order to realize this, the efforts are focused on research and development for further improvement in traffic safety and convenience through research and development related to preventive safety technology. In connection with this, recently, regarding a driving support device in which collision avoidance steering support control for automatically steering a steering wheel of a host vehicle is started to avoid a collision between the host vehicle and an obstacle when it is judged that a driver has performed a collision avoidance steering operation and the foregoing control ends when a driver's operation (avoidance support steering override) against the intention of the control is detected while the foregoing control is being executed, a technology in which ending of the foregoing control is prohibited with detection of the avoidance support steering override during a period until a predetermined time has elapsed from the start of the control has been disclosed (for example, Japanese Unexamined Patent Application, First Publication No. 2020-26207).

### SUMMARY

Incidentally, in preventive safety technology, vehicle control for calling attention of an occupant of a vehicle to the surroundings is sometimes performed at a stage before control for avoiding contact between the vehicle and a target is performed, but judgment of override considering such a case has not been taken into account. For this reason, in the related art, a problem has been that it may not be possible to make appropriate override judgment corresponding to details of vehicle control being executed.

In order to resolve the foregoing problems, an object of this application is to provide a vehicle control device, a vehicle control method, and a storage medium, in which more appropriate override judgment can be made in accordance with details of vehicle control being executed. Further, this will ultimately contribute to development of sustainable transportation systems.

A vehicle control device, a vehicle control method, and a storage medium according to this invention employ the following constitutions.

(1): A vehicle control device according to an aspect of this invention is a vehicle control device including a recognizer that recognizes a surrounding situation of a vehicle, a vehicle controller that executes vehicle control for controlling at least one of acceleration/deceleration and steering of the vehicle when there is a probability of contact between the vehicle and an obstacle on the basis of recognition results of the recognizer, and a driving state detector that detects a driving state of an occupant of the vehicle. The vehicle control includes alarm control for notifying the occupant when the vehicle approaches the obstacle, and avoidance control for avoiding contact with the obstacle when the vehicle has approached further toward the obstacle from in the alarm control. The vehicle controller suspends the alarm control when a steering operation equal to or more than a predetermined amount from a reference value is detected due to a steering operation of the occupant detected by the driving state detector during the alarm control, and does not suspend the avoidance control when a steering operation equal to or more than a predetermined amount from the reference value is detected during the avoidance control.

(2): According to the aspect of the foregoing (1), the vehicle controller suspends the avoidance control when a steering operation for the reference value is detected during the avoidance control.

(3): According to the aspect of the foregoing (1), the vehicle controller judges whether or not to suspend the avoidance control through a steering operation for returning to the reference value when a steering operation equal to or more than a predetermined amount from the reference value is first detected in the avoidance control.

(4): According to the aspect of the foregoing (1), the vehicle controller suspends the avoidance control when a steering operation for returning to the reference value is detected after a steering operation equal to or more than a predetermined amount from the reference value has been detected during the avoidance control.

(5): According to the aspect of the foregoing (1), the steering operation includes an operation based on an amount of change in steering derived by an amount of steering by the occupant and a steering angular velocity.

(6): According to the aspect of the foregoing (1), the alarm control includes steering control for moving the vehicle to a center of a traveling lane.

(7): A vehicle control method according to another aspect of the present invention is a vehicle control method in which a computer recognizes a surrounding situation of a vehicle, executes vehicle control for controlling at least one of acceleration/deceleration and steering of the vehicle when there is a probability of contact between the vehicle and an obstacle on the basis of recognized results, and detects a driving state of an occupant of the vehicle. The vehicle control includes alarm control for notifying the occupant when the vehicle approaches the obstacle, and avoidance control for avoiding contact with the obstacle when the vehicle has approached further toward the obstacle from in the alarm control. The alarm control is suspended when a steering operation equal to or more than a predetermined amount from a reference value is detected due to a steering operation of the occupant during the alarm control. The avoidance control is not suspended when a steering operation equal to or more than a predetermined amount from the reference value is detected during the avoidance control.

(8): A storage medium according to another aspect of the present invention is a computer readable non-transitory storage medium which stores a program causing a computer to recognize a surrounding situation of a vehicle, to execute vehicle control for controlling at least one of acceleration/deceleration and steering of the vehicle when there is a probability of contact between the vehicle and an obstacle on the basis of recognized results, and to detect a driving state of an occupant of the vehicle. The vehicle control includes alarm control for notifying the occupant when the vehicle approaches the obstacle, and avoidance control for avoiding contact with the obstacle when the vehicle has approached further toward the obstacle from in the alarm control. The alarm control is suspended when a steering operation equal to or more than a predetermined amount from a reference value is detected due to a steering operation of the occupant during the alarm control. The avoidance control is not suspended when a steering operation equal to or more than a predetermined amount from the reference value is detected during the avoidance control.

According to the aspects of the foregoing (1) to (8), it is possible to make more appropriate override judgment in accordance with details of vehicle control being executed.

### BRIEF DESCRIPTION OF THE DRAWINGS

FIG. 1 is a view of a constitution of a vehicle in which a vehicle control device of an embodiment is mounted.

FIG. 2 is a view of a functional constitution of a vehicle controller.

FIG. 3 is an explanatory view of details of vehicle control related to contact avoidance.

FIG. 4 is an explanatory view of details of attention calling control.

FIG. 5 is an explanatory view of details of contact attention alarm control.

FIG. 6 is an explanatory view of details of automatic steering avoidance control.

FIG. 7 is an explanatory view of steering control after a driver steering trigger.

FIG. 8 is an explanatory view of speed conditions of a host vehicle M for starting control for each operation phase.

FIG. 9 is an explanatory view of override control with respect to braking control.

FIG. 10 is an explanatory view of steering override.

FIG. 11 is an explanatory view of timings of judging override during vehicle control.

FIG. 12 is an explanatory view of rise and fall in amount of change in steering torque.

FIG. 13 is an explanatory view of timings of judging a driver steering trigger.

FIG. 14 is a flowchart showing an example of processing executed by a driving support device according to the embodiment.

FIG. 15 is a flowchart showing an example of override judgment processing.

### DESCRIPTION OF EMBODIMENT

Hereinafter, with reference to the drawings, an embodiment of a vehicle control device, a vehicle control method, and a storage medium according to the present invention will be described.

### Overall Constitution

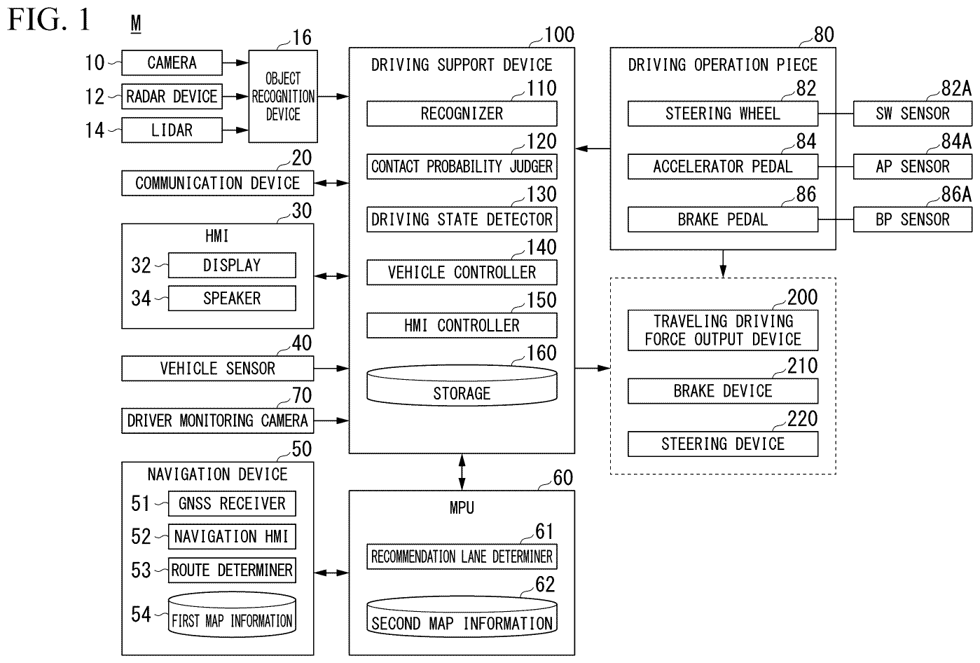

FIG. 1 is a view of a constitution of a vehicle in which a vehicle control device of an embodiment is mounted. A vehicle in which the vehicle control device is mounted (hereinafter, a host vehicle M) is a vehicle, for example, having two wheels, three wheels, four wheels, or the like, and a drive source thereof is an internal-combustion engine such as a diesel engine or a gasoline engine, an electric motor, or a combination of these. An electric motor is operated using generated power by a generator connected to an internal-combustion engine, or discharge power of a secondary battery or a fuel cell.

In the host vehicle M, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitoring camera 70, a driving operation piece 80, a driving support device 100, a traveling driving force output device 200, a brake device 210, and a steering device 220 are mounted. These devices and instruments are connected to each other through a multiplex communication line such as a controller area network (CAN) communication line, a serial communication line, a wireless communication network, or the like. The constituents shown in FIG. 1 are merely an example. Some of the constituents may be omitted, and other constituents may further be added thereto. The driving support device 100 is an example of “a vehicle control device”.

For example, the camera 10 is a digital camera utilizing a solid-state image capturing element such as a charge coupled device (CCD) or a complementary metal oxide semiconductor (CMOS). The camera 10 is attached to an arbitrary location in the host vehicle M. For example, when images on the side in front of the host vehicle M are captured, the camera 10 is attached to an upper part of a front windshield, a rear surface of a rearview mirror, or the like. For example, the camera 10 captures images around the host vehicle M periodically and repeatedly. The camera 10 may be a stereo camera.

The radar device 12 radiates radio waves such as millimeter waves around the host vehicle M and detects at least the position (distance and azimuth) of an object by detecting radio waves (reflected waves) reflected by the object. The radar device 12 is attached to an arbitrary location in the host vehicle M. The radar device 12 may detect the position and the speed of an object by a frequency modulated continuous wave (FM-CW) method.

The LIDAR 14 emits light (or electromagnetic waves having wavelengths close to that of light) around the host vehicle M and measures scattered light. The LIDAR 14 detects the distance to a target on the basis of the time from light emission to light reception. For example, emitted light is pulsed laser light. The LIDAR 14 is attached to an arbitrary location in the host vehicle M.

The object recognition device 16 recognizes the position, the kind, the speed, and the like of an object by performing sensor fusion processing with respect to detection results of some or all of the camera 10, the radar device 12, and the LIDAR 14. The object recognition device 16 outputs recognition results to the driving support device 100. The object recognition device 16 may output the detection results of the camera 10, the radar device 12, and the LIDAR 14 to the driving support device 100 without any change. The object recognition device 16 may be omitted from the host vehicle M. Some or all of the camera 10, the radar device 12, the LIDAR 14, and the object recognition device 16 are examples of “an external detection device”.

For example, the communication device 20 communicates with different vehicles present around the host vehicle M utilizing a cellular network, a Wi-Fi network, Bluetooth (registered trademark), dedicated short range communication (DSRC), or the like or communicates with various server devices via a wireless base station.

The HMI 30 provides various information to an occupant of the host vehicle M and receives an input operation of the occupant. For example, the HMI 30 includes a display 32 and a speaker 34. For example, the display 32 is a liquid crystal display (LCD), an electroluminescence (EL) display device, or the like. The display 32 displays various images (including video images) according to the embodiment. The display 32 may be constituted integrally with an input as a touch panel. The speaker 34 outputs predetermined audio (for example, an alarm or the like). In addition to (or instead of) the display 32 and the speaker 34, the HMI 30 may be a microphone, a buzzer, a vibration generation device (vibrator), a touch panel, a switch, a key, or the like.

The vehicle sensor 40 includes a vehicle speed sensor for detecting a speed of the host vehicle M, an acceleration sensor for detecting an acceleration, a yaw rate sensor for detecting a yaw rate (for example, a rotational angular velocity around a vertical axis passing through the center of gravity of the host vehicle M), a steering angle sensor for detecting a steering angle (an angle of a steering wheel (actual steering angle) or a torque amount of the host vehicle M), an azimuth sensor for detecting a direction of the host vehicle M, and the like. The vehicle sensor 40 may be provided with a position sensor for detecting a position of the host vehicle M. For example, the position sensor is a sensor for acquiring positional information (information of longitude and latitude) from a global positioning system (GPS) device. The position sensor may be a sensor for acquiring positional information using a global navigation satellite system (GNSS) receiver 51 of the navigation device 50.

For example, the navigation device 50 includes the GNSS receiver 51, a navigation HMI 52, and a route determiner 53. In the navigation device 50, first map information 54 is retained in a storage device such as a hard disk drive (HDD) or a flash memory. The GNSS receiver 51 identifies the position of the host vehicle M on the basis of a signal received from a GNSS satellite. The position of the host vehicle M may be identified or complemented by an inertial navigation system (INS) utilizing an output of the vehicle sensor 40. The navigation HMI 52 includes a display device, a speaker, a touch panel, a key, and the like. Some or all of the navigation HMI 52 may be shared by the HMI 30 described above. For example, the route determiner 53 determines a route from the position of the host vehicle M identified by the GNSS receiver 51 (or an arbitrary input position) to a destination input by an occupant (hereinafter, a route on a map) using the navigation HMI 52 with reference to the first map information 54. For example, the first map information 54 is information in which road shapes are expressed by links indicating roads and nodes connected by the links. The first map information 54 may include curvatures of roads, point-of-interest (POI) information, and the like. The route on the map is output to the MPU 60. The navigation device 50 may perform route guide using the navigation HMI 52 on the basis of the route on the map. For example, the navigation device 50 may be realized by a function of a terminal device such as a smartphone or a tablet terminal possessed by an occupant. The navigation device 50 may transmit a current position and a destination to a navigation server via the communication device 20 and acquire a route equivalent to the route on the map from the navigation server.

For example, the MPU 60 includes a recommendation lane determiner 61 and retains second map information 62 in a storage device such as an HDD or a flash memory. The recommendation lane determiner 61 divides the route on the map provided from the navigation device 50 into a plurality of blocks (for example, divides it into blocks of 100 [m] in a vehicle proceeding direction) and determines a recommendation lane for each block with reference to the second map information 62. The recommendation lane determiner 61 determines which lane from the left the vehicle should travel. When a branch point is present in the route on the map, the recommendation lane determiner 61 determines a recommendation lane such that the host vehicle M can travel along a reasonable route to proceed to a branch destination. The second map information 62 is map information that is more accurate than the first map information 54. For example, the second map information 62 includes information of a center of a lane, lane boundary information such as road division lines dividing a lane, or the like. The second map information 62 may include road information, traffic regulation information, address information (address, postal code), facility information, telephone number information, and the like. The second map information 62 may be updated at any time by the communication device 20 through communication with other devices. The first map information 54 and the second map information 62 may be stored in a storage inside the driving support device 100.

For example, the driver monitoring camera 70 is a digital camera utilizing a solid-state image capturing element such as a CCD or a CMOS. The driver monitoring camera 70 is attached to an arbitrary location in the host vehicle M in a position and a direction in which images of the head and the upper body (including positions of the hands) of an occupant seated in a driver's seat (hereinafter, a driver) of the host vehicle M can be captured from the front (in a direction in which images of the face are captured). For example, the driver monitoring camera 70 is attached to an upper part of the display device provided in the central part of an instrument panel of the host vehicle M. Therefore, since images captured by the driver monitoring camera 70 include the driver and a steering wheel 82, it is also possible to judge whether or not the driver is gripping the steering wheel 82 from the captured images. The driver monitoring camera 70 captures images of the inside of a cabin including the driver of the host vehicle M from the disposed position in a predetermined cycle and outputs the captured images to the driving support device 100.

For example, the driving operation piece 80 includes the steering wheel 82, an accelerator pedal 84, a brake pedal 86, an operation switch of a direction indicator, a shift lever, and other operation pieces. A sensor for detecting an amount of operation or whether there is an operation is attached to the driving operation piece 80, and detection results thereof are output to some or all of the driving support device 100, the traveling driving force output device 200, the brake device 210, and the steering device 220.

For example, the steering wheel 82 is provided with a steering wheel sensor (SW sensor) 82A. The SW sensor 82A detects whether or not the driver is gripping the steering wheel 82 by means of a contact sensor, a pressure sensor, or the like. The SW sensor 82A detects the amount of operation (steering torque, amount of steering) or the operation speed (steering angular velocity) of the steering wheel 82 input (operated) by the driver. The SW sensor 82A may detect an operation change rate (torque change rate). The steering wheel 82 does not necessarily have an annular shape and may be in a form of a deformed steering wheel, a joystick, a button, or the like. In that case, the SW sensor 82A detects the amount of operation corresponding to each form.

The accelerator pedal 84 is attached to an accelerator pedal sensor (AP sensor) 84A. The AP sensor 84A detects the amount of operation (opening degree) of the accelerator pedal 84 changing in accordance with a driver's operation with respect to the accelerator pedal 84. The brake pedal 86 is provided with a brake pedal sensor (BP sensor) 86A. The BP sensor 86A detects the amount of operation (opening degree) of the brake pedal 86 changing in accordance with a driver's operation with respect to the brake pedal 86.

The traveling driving force output device 200 outputs a traveling driving force (torque) for causing the host vehicle M to travel to driving wheels. For example, the traveling driving force output device 200 includes a combination of an internal-combustion engine, an electric motor, a transmission, and the like, and an electronic control unit (ECU) controlling these. The ECU controls the foregoing constituents in accordance with information input from the driving support device 100 or information input from the driving operation piece 80.

For example, the brake device 210 includes a brake caliper, a cylinder transmitting a hydraulic pressure to the brake caliper, an electric motor generating a hydraulic pressure in the cylinder, and an ECU. The ECU controls the electric motor in accordance with information input from the driving support device 100 or information input from the driving operation piece 80 such that a brake torque corresponding to a braking operation is output to each of the wheels. The brake device 210 may include, as a backup, a mechanism for transmitting a hydraulic pressure generated through an operation of the brake pedal included in the driving operation piece 80 to the cylinder via a master cylinder. The brake device 210 is not limited to the constitution described above and may be an electronically controlled hydraulic brake device transmitting a hydraulic pressure of the master cylinder to the cylinder by controlling an actuator in accordance with information input from the driving support device 100.

For example, the steering device 220 includes a steering ECU and an electric motor. For example, the electric motor causes a force to act on a rack-and-pinion mechanism to change the direction of steered wheels. The steering ECU drives the electric motor in accordance with information input from the driving support device 100 or information input from the driving operation piece 80 and changes the direction of the steered wheels.

### Driving Support Device

For example, the driving support device 100 includes a recognizer 110, a contact probability judger 120, a driving state detector 130, a vehicle controller 140, an HMI controller 150, and a storage 160. For example, the recognizer 110, the contact probability judger 120, the driving state detector 130, the vehicle controller 140, and the HMI controller 150 are realized by a hardware processor such as a central processing unit (CPU) executing a program (software). Some or all of these constituent elements may be realized by hardware (circuit; including circuitry) such as a large scale integration (LSI), an application specific integrated circuit (ASIC), a field-programmable gate array (FPGA), or a graphics processing unit (GPU), or may be realized by software and hardware in cooperation. A program may be stored in a storage device such as an HDD or a flash memory (a storage device including a non-transitory storage medium) of the driving support device 100 in advance or may be stored in an attachable/detachable storage medium such as a DVD or a CD-ROM such that the program is installed in the HDD or the flash memory of the driving support device 100 when the storage medium (non-transitory storage medium) is mounted in a drive device. The HMI controller 150 is an example of “a notification controller”.

For example, setting is performed inside the traveling driving force output device 200, the brake device 210, and the steering device 220 such that instructions from the driving support device 100 to the traveling driving force output device 200, the brake device 210, and the steering device 220 are executed with priority over detection results from the driving operation piece 80. Regarding braking, when a braking force based on the amount of operation of the brake pedal 86 is larger than that in an instruction from the driving support device 100, setting may be performed such that the latter is executed with priority. Regarding a structure for executing an instruction from the driving support device 100 with priority, a communication priority in an in-car local area network (LAN) may be used. Regarding steering, setting may be performed such that it is executed by adding a steering force based on an instruction from the driving support device 100 and a steering force based on the amount of operation of the steering wheel 82 by the driver.

The storage 160 may be realized by the various storage devices described above, a solid state drive (SSD), an electrically erasable programmable read only memory (EEPROM), a read only memory (ROM), a random access memory (RAM), or the like. For example, the storage 160 stores a program, information used in the constituents inside the driving support device 100, various other information, and the like. In addition, the storage 160 may store the map information (the first map information 54 and the second map information 62) described above.

The recognizer 110 recognizes the surrounding situation of the host vehicle M on the basis of information input from the external detection device. For example, the recognizer 110 recognizes a state of an object present around it (for example, within a predetermined distance from the host vehicle M), such as a position (relative position, inter-vehicle distance), a speed (relative speed), and an acceleration. For example, an object is a different vehicle, a bicycle, a pedestrian, or the like. For example, the position of an object is recognized as a position on absolute coordinates with an origin at a representative point (centroid, drive shaft center, or the like) in the host vehicle M and is used for control. The position of an object may be indicated by a representative point such as a centroid or a corner of the object or may be indicated as a region. A “state” of an object may include an acceleration or a jerk of the object or “an action state” (for example, whether or not it is making a lane change or attempting a lane change). The recognizer 110 recognizes the relative position and the relative speed with respect to an object.

For example, the recognizer 110 recognizes a lane in which the host vehicle M is traveling (traveling lane). For example, the recognizer 110 recognizes the traveling lane by comparing patterns (for example, arrays of solid lines and dotted lines) of road division lines obtained from the second map information 62 and patterns of road division lines around the host vehicle M recognized from images captured by the camera 10. The recognizer 110 may recognize the traveling lane by recognizing traveling path boundaries (road boundaries) including road division lines, road shoulders, curbstones, median strips, guardrails, and the like without being limited to road division lines. In this recognition, a position of the host vehicle M acquired from the navigation device 50 or processing results of the INS may be added. The recognizer 110 recognizes obstacles, stop lines, red lights, toll gates, and other road events from the recognition results of an object. Obstacles are objects with which the host vehicle M needs to avoid contact, and they include, for example, different vehicles, bicycles, pedestrians, and the like.

When recognizing the traveling lane, the recognizer 110 recognizes a position or a posture of the host vehicle M with respect to the traveling lane. For example, the recognizer 110 may recognize a deviation of a reference point in the host vehicle M from the center of the lane and an angle formed with respect to a line of the centers of the lane of the host vehicle M in the proceeding direction as a relative position and a posture of the host vehicle M with respect to the traveling lane. Instead of this, the recognizer 110 may recognize a position or the like of a reference point in the host vehicle M with respect to any side end part (road division line or road boundary) of the traveling lane as a relative position of the host vehicle M with respect to the traveling lane.

The contact probability judger 120 judges whether or not there is a probability of contact between an obstacle (for example, a different vehicle) and the host vehicle M on the basis of the surrounding situation (external information) recognized by the recognizer 110. For example, the contact probability judger 120 judges whether or not there is a probability of contact between the host vehicle M and a different vehicle on the basis of a contact margin value with respect to a different vehicle (preceding vehicle) present in front of the host vehicle M on the basis of the surrounding situation. For example, a contact margin value is a value set on the basis of a contact margin time TTC (time to collision), but it may be a value set on the basis of an inter-vehicle time THW (time headway). For example, in the relationship between the host vehicle M and a different vehicle, the contact margin time TTC is derived by dividing the relative distance by the relative speed. For example, the inter-vehicle time THW is derived by dividing the relative distance (inter-vehicle distance) by the speed of the host vehicle M. For example, the contact margin time TTC may be derived using a learned model in which the contact margin time TTC is output when the positions and the speeds of the host vehicle M and a different vehicle are input, a predetermined function, or the like, or it may be derived using a correspondence table in which the relative speed and the relative position are associated with the contact margin time TTC. Similarly, the foregoing derivation method also applies to the inter-vehicle time THW. For example, the shorter the contact margin time TTC (or the inter-vehicle time THW), the smaller the contact margin value (in other words, the longer the contact margin time, the larger the contact margin value). For example, the contact probability judger 120 judges that there is a probability of contact between the host vehicle M and a different vehicle when the contact margin value is smaller than a threshold, and it judges that there is no probability of contact when the contact margin value is equal to or larger than the threshold. Hereinafter, description will be given using the contact margin time TTC as an example of the contact margin value.

The driving state detector 130 detects the driving state of an occupant (driver) of the host vehicle M. For example, the driving state includes whether or not the steering wheel 82 is gripped or information related to an amount of steering operation (steering torque, amount of change in steering torque). The driving state may include information related to a steering speed or a steering angular velocity (velocity until a predetermined steering angular amount is attained) of the driver. In addition to (or instead of) the above, the driving state may be at least one of an accelerator operation or an amount of operation (opening degree) by the accelerator pedal 84, and a brake operation or an amount of operation (opening degree) by the brake pedal 86. For example, the driving state is acquired on the basis of detection results of the SW sensor 82A, the AP sensor 84A, and the BP sensor 86A, or information obtained from the vehicle sensor 40 and the driver monitoring camera 70. The driving state detector 130 may detect a state in which the driver is not performing a driving operation (steering operation, accelerator operation, brake operation) on the basis of detection results of each sensor.

The driving state detector 130 may detect that the driver's state is not a state appropriate for driving on the basis of analysis results of images captured by the driver monitoring camera 70. For example, the driving state detector 130 detects that the driver's state is not a state appropriate for driving when the driver is not monitoring the surroundings (particularly the front) of the host vehicle M by looking away or the like, or when it is predicted that driver's concentration has decreased based on predetermined facial expression (drowsy face, painful face) or the like on the basis of the foregoing analysis results of images.

The driving state detector 130 may judge distracted driving of the driver on the basis of the detection results or the like described above. For example, distracted driving is driving in a state in which a driving operation of the host vehicle M becomes slow (or is not operated) due to decrease in driver's attentiveness or the like. For example, based on detection results of the SW sensor 82A, the driving state detector 130 judges that the driver is performing distracted driving when a state in which a steering operation of the steering wheel 82 by the driver is smaller than a predetermined threshold continues for a predetermined time or longer, and it judges that no distracted driving is being performed when the state does not continue for the predetermined time or longer.

Instead of (or in addition to) a driver's steering operation, the driving state detector 130 may judge that the driver is performing distracted driving when a state in which the amounts of change in opening degree of the accelerator pedal 84 and the brake pedal 86 are smaller than thresholds continues for a predetermined time or longer based on detection results of the AP sensor 84A and the BP sensor 86A. Instead of (or in addition to) the foregoing judgment, the driving state detector 130 may judge that the driver is performing distracted driving when a state detecting that the driver's state is not a state appropriate for driving continues for the predetermined time or longer, and it may judge that no distracted driving is being performed when the state does not continue for the predetermined time or longer. Judgment of distracted driving may be comprehensively decided based on judgment results under the plurality of conditions described above.

The predetermined time described above may be a fixed time or may also be a variable time. For example, the predetermined time may be set in accordance with the contact margin time TTC between an obstacle (for example, a preceding vehicle) around the host vehicle M and the host vehicle M, and the speed of the host vehicle M. Specifically, the predetermined time is set to be shorter as the speed of the host vehicle M becomes higher, and the predetermined time is set to be shorter as the contact margin time TTC becomes shorter. Accordingly, distracted driving can be judged more appropriately on the basis of the situation of the host vehicle M and the surrounding situation based on the speed of the host vehicle M and the positional relationship between the host vehicle M and an obstacle.

The vehicle controller 140 controls one or both steering and acceleration/deceleration of the host vehicle M on the basis of the surrounding situation recognized by the recognizer 110. Moreover, the vehicle controller 140 may control one or both steering and acceleration/deceleration of the host vehicle M on the basis of processing results of at least one of the contact probability judger 120 and the driving state detector 130. The vehicle controller 140 may perform control in which vehicle control being executed is suspended and switched to driver's manual driving (override control) in accordance with a predetermined driving operation of the driver during vehicle control. Details of processing of the vehicle controller 140 will be described below.

The HMI controller 150 notifies the occupant (including the driver) of predetermined information through the HMI 30. For example, the predetermined information includes information related to traveling of the host vehicle M, such as information related to the state of the host vehicle M and information related to driving control. For example, the information related to the state of the host vehicle M includes a speed of the host vehicle M, a rotation frequency of the engine, a shift position, and the like. For example, the information related to driving control includes the kind of driving control being executed (for example, slow deceleration control, centering steering control, contact avoidance braking control, contact avoidance steering control), the reason for the operation of driving control, the situation of driving control, and the like. The information related to driving control may include information related to attention calling and a contact attention alarm with respect to the driver. The predetermined information may include information and the like related to a current position, a destination, and a remaining amount of fuel of the host vehicle M, and it may include information which is not related to traveling control of the host vehicle M, such as TV programs and contents (for example, movies) stored in a storage medium such as a DVD.

For example, the HMI controller 150 may generate images including the predetermined information described above and cause the display 32 of the HMI 30 to display the generated images or may generate audio indicating predetermined information and output the generated audio from the speaker 34 of the HMI 30. For example, the timing of outputting audio is a timing when driving control is started or suspended, a timing of switching images to be displayed, a timing when the host vehicle M is in a predetermined state, or the like. The HMI controller 150 may output information received through the HMI 30 to the vehicle controller 140 and the like.

### Vehicle Controller

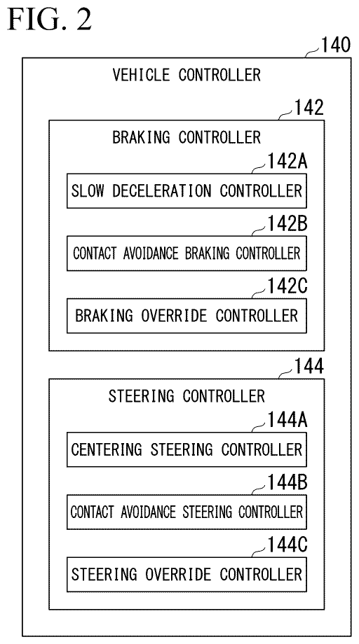

Next, details of the vehicle controller 140 will be described. FIG. 2 is a view of a functional constitution of the vehicle controller 140. For example, the vehicle controller 140 includes a braking controller 142 and a steering controller 144. The vehicle controller 140 performs alarm control and avoidance control for avoiding contact between the host vehicle M and an obstacle under control by the braking controller 142 and the steering controller 144. Alarm control is control which operates when the host vehicle M approaches an obstacle, and it includes, for example, slow deceleration control, centering steering control, and the like which will be described below. Avoidance control is control which operates when the host vehicle M has approached further toward an obstacle from when alarm control operates, and it includes, for example, contact avoidance braking control, contact avoidance steering control, and the like which will be described below.

When it is judged that an obstacle is present in front of the host vehicle M on the basis of recognition results of the recognizer 110, the braking controller 142 performs braking control of the host vehicle M on the basis of a target deceleration rate of the host vehicle M. For example, the braking controller 142 sets a deceleration state on the basis of the contact margin time TTC between the host vehicle M and an obstacle and executes deceleration control based on the set deceleration state. For example, the braking controller 142 includes a slow deceleration controller 142A, a contact avoidance braking controller 142B, and a braking override controller 142C.

When the recognizer 110 judges that an obstacle (for example, a different vehicle) is present in front of the host vehicle M, the slow deceleration controller 142A performs the slow deceleration control of the host vehicle M. The slow deceleration control is control for notifying the driver of an approaching obstacle based on the vehicle behavior (change in longitudinal G) such as deceleration and calling attention to the obstacle (attention calling control), and it is control different from contact avoidance control for avoiding contact with an obstacle (however, there may be a case in which contact with an obstacle is avoided consequently). For example, when it is judged that an obstacle is present in front of the host vehicle M, the slow deceleration controller 142A derives the target deceleration rate of the host vehicle M and decelerates the host vehicle M without depending on a driver's operation so as to reach the derived target deceleration rate. The slow deceleration control may be executed when the driving state detector 130 detects that the driver is performing distracted driving or may be executed when the contact margin value satisfies operation conditions for the slow deceleration control.

When the driving state detector 130 detects a driver's accelerator operation (operation of the accelerator pedal 84) equal to or larger than a predetermined value (for example, a predetermined amount) during the slow deceleration control, the slow deceleration controller 142A may suspend the slow deceleration control. In this manner, it is possible to execute more appropriate override control (control for switching to driver's manual driving) with respect to the slow deceleration control by judging the driver's intention through an accelerator operation. The predetermined value (predetermined amount) may be changed on the basis of the operation speed of the driver's accelerator operation. For example, when the operation speed is equal to or higher than a predetermined speed, the slow deceleration controller 142A sets a smaller predetermined value than when it is lower than the predetermined speed, and when it is lower than the predetermined speed, a larger predetermined value than when it is equal to or higher than the predetermined speed is set. For example, the slow deceleration controller 142A may change the predetermined value in accordance with the target deceleration rate and set a larger predetermined value as the target deceleration rate increases. Accordingly, it is possible to realize more appropriate override judgment in accordance with the driver's driving situation or the surrounding situation of the host vehicle M.

The contact avoidance braking controller 142B performs emergency brake control for avoiding contact between the host vehicle M and an obstacle. For example, when it is judged that there is a probability of contact of the host vehicle M with an obstacle based on the surrounding situation recognized by the recognizer 110, the contact avoidance braking controller 142B performs braking control for avoiding contact (deceleration control). The braking control executed by the contact avoidance braking controller 142B includes, for example, collision mitigation brake system (CMBS) control for supporting contact avoidance or damage reduction. For example, the braking control executed by the contact avoidance braking controller 142B may be executed after the slow deceleration control or may be executed when the contact margin value satisfies operation conditions for the contact avoidance braking control.

The braking override controller 142C judges whether or not to perform the override control (override judgment) through a driver's driving operation (driver's operation) executing the braking control described above (slow deceleration control, contact avoidance braking control). A driver's operation used for override judgment during the braking control is an accelerator operation or a brake operation. When it is judged that the override control is being performed, the braking override controller 142C suspends the braking control being executed.

The steering controller 144 controls steering of the host vehicle M. For example, the steering controller 144 includes a centering steering controller 144A, a contact avoidance steering controller 144B, and a steering override controller 144C.

When the recognizer 110 judges that an obstacle is present in front of the host vehicle M, the centering steering controller 144A executes the steering control for moving the host vehicle M toward the center of the traveling lane (centering steering control). This steering control is not intended to avoid contact with an obstacle but is control for notifying the driver of an approaching obstacle based on the vehicle behavior (change in lateral G) of laterally moving to a part near the center and calling attention to the obstacle (however, there may be a case in which contact with an obstacle is avoided consequently). This steering control makes it possible for the driver to be aware of an obstacle in front at an early stage and can contribute to driving for avoiding contact. The centering steering control may be executed when the driving state detector 130 detects that the driver is performing distracted driving or may be executed when the contact margin value satisfies operation conditions for the steering control. The slow deceleration control and the centering steering control described above may be separately executed or may be simultaneously executed at the same timing (for example, at the stage of the attention calling control).

The contact avoidance steering controller 144B performs steering control of the host vehicle M for avoiding contact between the host vehicle M and an obstacle. For example, when avoidance is possible within the traveling lane of the host vehicle M, the contact avoidance steering controller 144B performs a steering operation of moving in a direction in which the host vehicle M does not come into contact with an obstacle within a range not departing from the same lane without depending on a driver's steering operation. The contact avoidance steering controller 144B may perform the steering control of the host vehicle M such that the behavior of the host vehicle M after an avoidance operation is made stable after the host vehicle M has performed an operation of avoiding an obstacle by straddling a division line dividing the traveling lane through a driver's steering operation. For example, the steering control executed by the contact avoidance steering controller 144B may be executed after the centering steering control or may be executed when the contact margin value satisfies operation conditions for the foregoing steering control.

The steering override controller 144C judges whether or not to perform the override control through a driver's operation executing the steering control (centering steering control, contact avoidance steering control). A driver's operation used for override judgment during the steering control is a steering operation. When it is judged that the override control is being performed, the steering override controller 144C suspends the steering control being executed.

The vehicle controller 140 may execute control other than the vehicle control described above. For example, the vehicle controller 140 may control steering such that the host vehicle M is kept within the traveling lane as lane keeping assistance system (LKAS) control. In this case, for example, the vehicle controller 140 supports a driver's steering operation by controlling the steering device 220 such that the host vehicle M does not depart from the traveling lane. The steering override controller 144C may judge whether or not to perform the override control through a driver's operation executing the LKAS control and suspend the LKAS control being executed when it is judged that the override control is being performed.

### Regarding Vehicle Control for Contact Avoidance

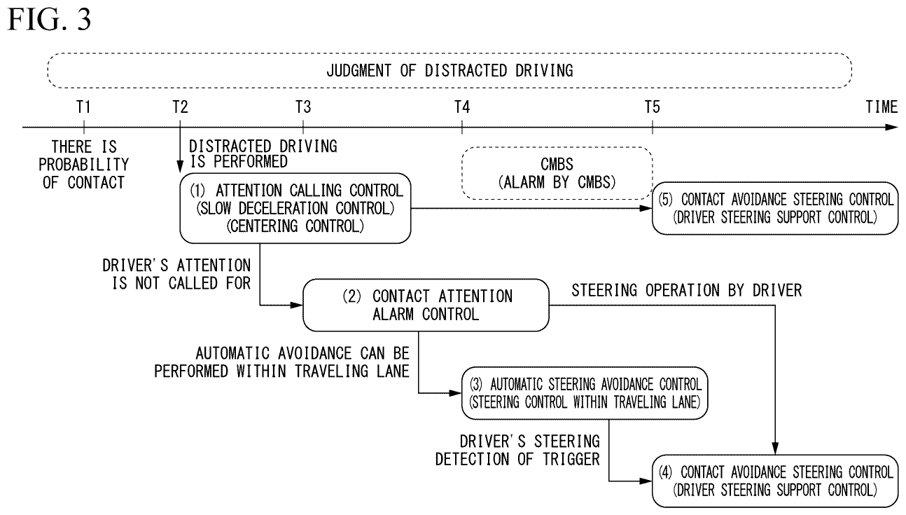

Next, details of vehicle control for contact avoidance according to the embodiment will be specifically described. In the following description, it is assumed that an obstacle is a different vehicle (preceding vehicle) traveling in front of the host vehicle M. FIG. 3 is an explanatory view of details of vehicle control related to contact avoidance. The example in FIG. 3 shows details of the vehicle control when it is judged that there is a probability of contact based on the contact margin time TTC. In the example in FIG. 3, it is assumed that a time T1 is the earliest followed by times T2, T3, T4, and T5 in this order. In the example in FIG. 3, it is assumed that the driving state detector 130 continuously judges whether or not distracted driving is being performed in a predetermined cycle from the stage before the time T1.

First, at the time T1, it is assumed that the contact probability judger 120 has judged that there is a probability of contact between the host vehicle M and a different vehicle. When it is judged that there is a probability of contact, the vehicle controller 140 performs the attention calling control ((1) in the diagram) for calling attention of the driver to the surroundings (particularly in the proceeding direction) on the basis of the contact margin time TTC and the result of judgment of distracted driving.

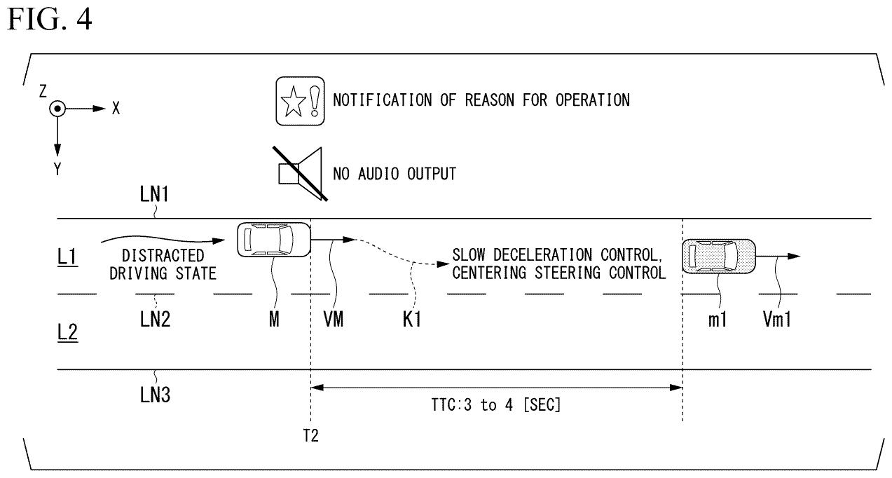

FIG. 4 is an explanatory view of details of attention calling control. The example in FIG. 4 shows two lanes L1 and L2 allowing proceeding in the same direction (X axis direction in the diagram). The lane L1 is divided by road division lines LN1 and LN2, and the lane L2 is divided by road division lines LN2 and LN3. In the example in FIG. 4, it is assumed that the host vehicle M travels on the lane L1 at a speed VM and a different vehicle m1 is present in front of the host vehicle M and travels on the lane L1 at a speed Vm1.

In the example in FIG. 4, the vehicle controller 140 performs the attention calling control when the contact margin time TTC based on the relative position and the relative speed between the host vehicle M and the different vehicle m1 becomes the time T2 which is shorter than a first predetermined time and when it is judged that the driver is performing distracted driving. For example, the time T2 is a time at which the contact margin time TTC becomes approximately 3 to 4 [sec].

For example, the attention calling control includes at least one of the slow deceleration control and the centering steering control. The slow deceleration control executed in the attention calling control is control in a first deceleration state. The slow deceleration controller 142A sets a target deceleration rate (first target deceleration rate) such that a load (longitudinal G) of a first upper limit deceleration rate (approximately 0.1 [G]) is applied to the driver in the proceeding direction (vertical direction). In the attention calling control (first deceleration state), the slow deceleration controller 142A may first perform the slow deceleration control at a first deceleration degree (for example, a longitudinal G of 0.05 [G]) and then may perform the deceleration control at a second deceleration degree (for example, a longitudinal G of 0.1 [G]) larger than the first deceleration degree. By performing control such that the deceleration degree increases in stages in this manner, it is possible to reduce a load on an occupant such as a driver at the time of starting execution of the slow deceleration control and curb a situation in which an occupant is surprised due to the slow deceleration control.

In the attention calling control shown in FIG. 4 the centering steering controller 144A performs the centering steering control for steering such that the reference point such as the centroid or the center of the host vehicle M is positionally set at the center of the traveling lane (lane L1) on the basis of recognition results of the recognizer 110, map information, and the like. In the example in FIG. 4, the vehicle controller 140 generates a future target trajectory K1 for the host vehicle M corresponding to the slow deceleration control and the centering steering control and controls steering and the speed of the host vehicle M such that it travels along the target trajectory K1.

At the time T2, the HMI controller 150 may generate an image including information indicating a reason for the operation of the attention calling control (slow deceleration control, centering steering control) for the driver and issue a notification to the driver by causing the display 32 to display the generated image. The image may include information for calling attention. However, in this case, audio may not be output. Accordingly, it is possible to call attention by simply informing the driver of the fact that the host vehicle M is approaching the different vehicle m1, and the driver can be prompted to perform an avoidance operation at an early stage.

Returning to FIG. 3, when the contact margin time TTC becomes the time T3 which is shorter than a second predetermined time (second predetermined time <first predetermined time) in a state in which the driver does not pay attention to the surroundings (override control) although the attention calling control described above has been performed, and when it is judged that the driver is performing distracted driving, the contact attention alarm control is performed ((2) in FIG. 3). For example, the time T3 is a time at which the contact margin time TTC becomes approximately 2 [sec].

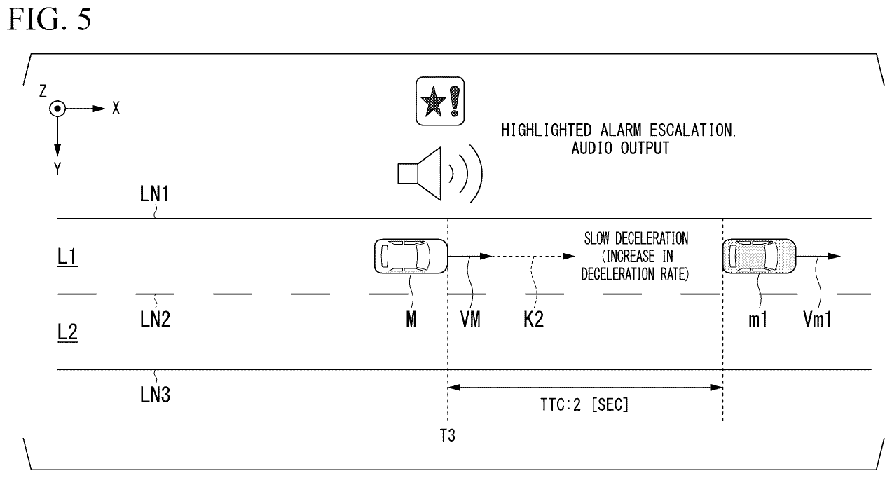

FIG. 5 is an explanatory view of details of contact attention alarm control. FIG. 5 shows a scene in which the contact margin time TTC has become 2 [sec] in a situation with no driver's accelerator operation from the situation shown in FIG. 4. At the stage of the contact attention alarm control, the slow deceleration controller 142A sets a target deceleration rate (second target deceleration rate) and executes the slow deceleration control corresponding to the set second target deceleration rate, and it generates a target trajectory K2 and performs control such that the host vehicle M travels along the generated target trajectory K2. The slow deceleration control executed in the contact attention alarm control is control in a second deceleration state. In the second deceleration state, the slow deceleration controller 142A sets a target deceleration rate (second target deceleration rate) such that a load (longitudinal G) equal to smaller than a second upper limit deceleration rate (approximately 0.2 [G]) and larger than the first upper limit deceleration rate is applied to the driver in the proceeding direction (vertical direction). Accordingly, the driver can be more clearly aware of that the host vehicle M is approaching the different vehicle m1. In this manner, since the deceleration control is performed while increasing the deceleration rate as necessary, it is possible to create more time to be aware of the different vehicle m1, and the driver can perform driving while avoiding contact with the different vehicle m1 with plenty of time.

At the time of the contact attention alarm control, in addition to (or instead of) the slow deceleration control, the centering steering control may be executed by the centering steering controller 144A. At the time of the contact attention alarm control, the HMI controller 150 may execute control such as highlighting an image of attention calling information displayed in the display 32, or causing the speaker 34 to output an alarm (alarm escalation control). Accordingly, while further decelerating the vehicle, it is possible to more clearly call attention or prompt the driver to perform the contact avoidance control by strongly notifying the driver of a high probability of contact using an image and sound. The attention calling control and the contact attention alarm control described above are control executed as “alarm control”.

Returning to FIG. 3, after the contact attention alarm control has been executed, the vehicle controller 140 executes automatic steering avoidance control at the time T4 when it is judged that automatic avoidance can be performed within the traveling lane based on the surrounding situation recognized by the recognizer 110 ((3) in FIG. 3). The time T4 is a time in a state in which the host vehicle M is closer to the different vehicle m1 than at the time T3 (for example, the contact margin time TTC is shorter than approximately 2 [sec]).

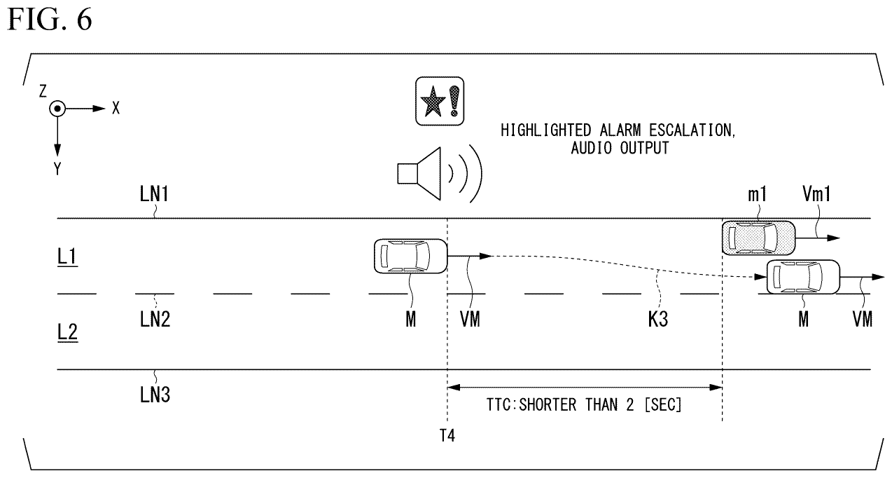

FIG. 6 is an explanatory view of details of automatic steering avoidance control. The example in FIG. 6 shows control in a case in which no predetermined accelerator operation is being performed by the driver after the contact attention alarm control has been executed. In this case, the contact avoidance steering controller 144B recognizes the region of the traveling lane (lane L1) and the position of the different vehicle m1 based on the recognition results of the recognizer 110. When an avoidance space is present within the traveling lane, steering control is executed such that a target trajectory K3 for traveling in the avoidance space is generated and the host vehicle M travels along the generated target trajectory K3. In this case, acceleration/deceleration control may be executed by the vehicle controller 140 as necessary. At the time of the automatic steering avoidance control, the HMI controller 150 may continuously execute the alarm escalation control described above. Accordingly, it is possible to realize more appropriate vehicle control by executing automatic steering control when steering avoidance can be performed under highly safe control.

In the vehicle controller 140, at the timing of the time T4, the contact avoidance braking controller 142B may execute the CMBS control in parallel. When the CMBS control is executed, the automatic steering avoidance control described above and driver steering support control which will be described below may not be executed. In this case, the HMI controller 150 may output an alarm (image, audio) related to the CMBS control.

Returning to FIG. 3, at the time T5 when the driver performs a steering operation in a direction in which the different vehicle m1 is avoided by operating the steering wheel 82 (by detecting a driver steering trigger), the contact avoidance steering controller 144B performs the contact avoidance steering control (driver steering support control) so as not to further depart from the adjacent lane (lane L2) adjacent to the traveling lane (lane L1) ((4) in FIG. 3). For example, a driver steering trigger indicates that the amount of steering torque of the driver for avoiding the different vehicle m1 becomes equal to or larger than a predetermined amount. The driver steering support control may be executed after the automatic steering avoidance control or may be executed after the contact attention alarm control (at the timing of the time T4 without performing the automatic steering avoidance control).

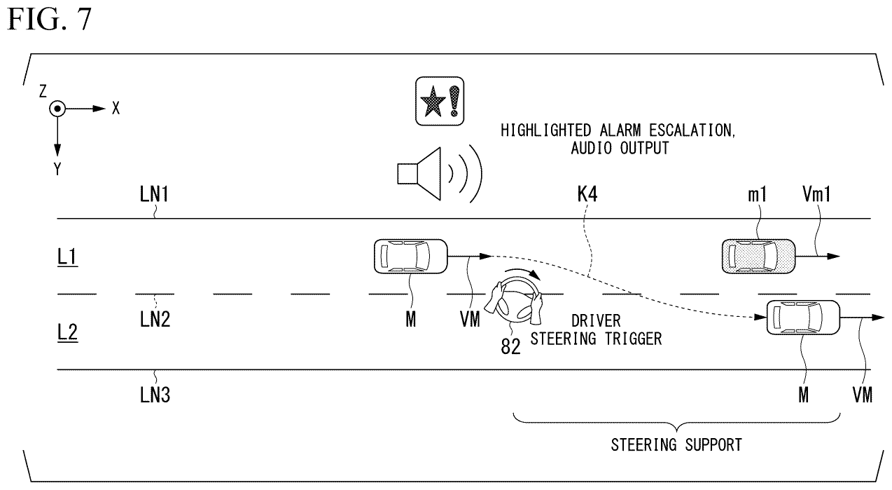

FIG. 7 is an explanatory view of steering control after a driver steering trigger. In the example in FIG. 7, when a space for the host vehicle M avoiding contact with the different vehicle m1 is not present on the lane L1, and when the driver steering trigger is detected, the contact avoidance steering controller 144B allows the host vehicle M to move from the lane L1 to the adjacent lane L2 and performs the steering control of the host vehicle M so as not to further depart from the adjacent lane L2. In this case, the contact avoidance steering controller 144B may generate a target trajectory K4 for a lane change to the lane L2 and execute steering support such that the position of the host vehicle M becomes close to the target trajectory K4 through a steering operation by the driver. The contact avoidance steering controller 144B may perform control so as to restrain the amount of steering by applying a reaction force to the steering wheel 82 against a driver's steering operation. At the time of the driver steering support control, the HMI controller 150 may continuously execute the alarm escalation control described above. Accordingly, it is possible to realize more appropriate vehicle control even when emergency avoidance steering is performed through a driver's steering operation.

Returning to FIG. 3, when the contact margin time TTC becomes close to a limit value after the attention calling control shown in (1) in FIG. 3, and when the driver has performed a steering operation, similar to the control of (4) in FIG. 3, the vehicle controller 140 executes the driver steering support control so as not to further cross the adjacent lane ((5) in FIG. 3). In this case, the HMI controller 150 may perform notification control such as a notification or an alarm for the driver steering support control being operated. The contact avoidance braking control and the contact avoidance steering control described above are control executed as “avoidance control”.

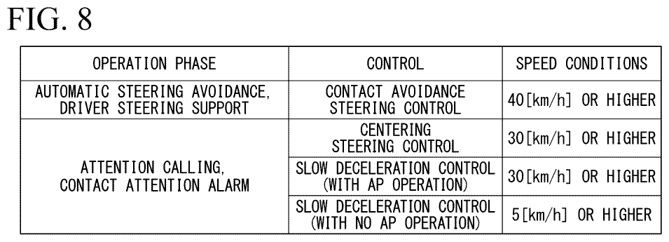

Here, in each operation phase of attention calling, contact attention alarm, automatic steering avoidance, contact avoidance steering shown in FIG. 3, satisfying a condition related to the speed of the host vehicle M may be added to judgment conditions for operation. FIG. 8 is an explanatory view of speed conditions of the host vehicle M for starting control for each operation phase. For example, regarding the contact avoidance steering control in the automatic steering avoidance or the driver steering support control, control is performed such that it is executed when the speed VM of the host vehicle M is 40 [km/h] or higher. Since this control is performed after attention calling, if the contact margin time TTC is approximately 2 [sec], it is sufficient to perform contact avoidance by a driver's brake operation. Regarding the centering steering control in attention calling and contact attention alarm, control is performed such that it is executed when the speed VM of the host vehicle M is 30 [km/h] or higher. Regarding the slow deceleration control in attention calling and contact attention alarm, when there is an accelerator operation (AP operation), control is performed such that it is executed when the speed VM of the host vehicle M is 30 [km/h] or higher. Since this speed falls below a steering avoidance limit speed and is within a range allowing a performance margin for the CMBS control, it is possible to realize more appropriate driving control by setting these conditions. When there is no AP operation, control is performed such that it is executed when the speed VM of the host vehicle M is 5 [km/h] or higher. Namely, a lower speed is set when no driver's AP operation is detected than when an AP operation has been detected. Accordingly, by mitigating the conditions for starting the slow deceleration control in a situation with no AP operation, the slow deceleration control can be executed in diverse situations, including a distracted driving state in congestion, and contact between the host vehicle M and the different vehicle m1 can be avoided more safely.

### Braking Override

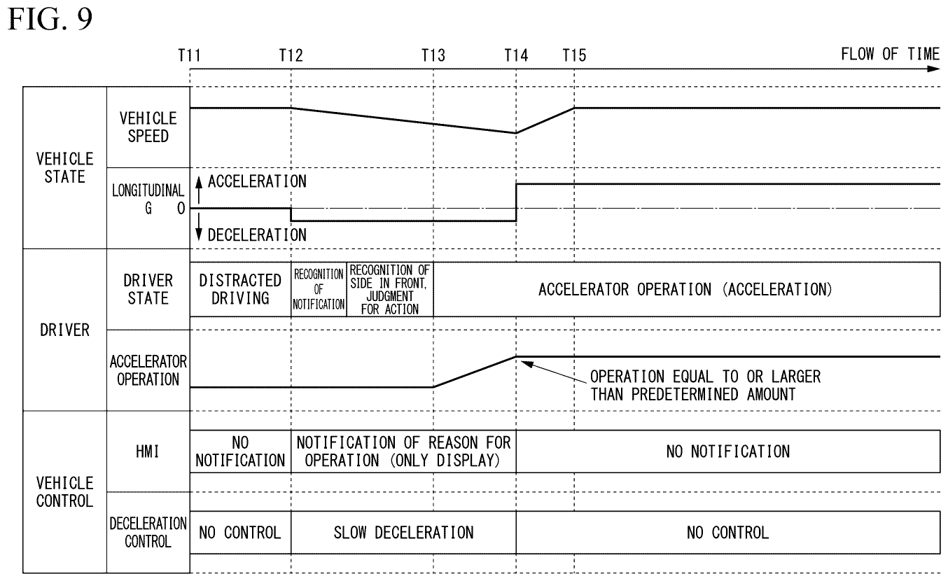

Next, override control performed by the braking override controller 142C will be described. FIG. 9 is an explanatory view of override control with respect to braking control. The example in FIG. 9 describes override control with respect to the slow deceleration control. The example in FIG. 9 shows respective states of the host vehicle M, the driver, and vehicle control (for example, output to the HMI 30, and deceleration (braking) control) along with the flow of time when the host vehicle M and the different vehicle m1 (preceding vehicle) are present on the lane L1 as shown in FIG. 4 and the like. In the example in FIG. 9, it is assumed that a time T11 is the earliest followed by T12, T13, T14, and T15 in this order.

The period from the times T11 to T12 shown in FIG. 9 is a state in which it is judged that the driver is in a distracted driving state. During this period, the driver performs an AP operation, and the host vehicle M is traveling at a constant speed (longitudinal G is 0 (zero)). No information is output to the HMI 30, and the deceleration control is not executed either.

After the time T12, since the vehicle controller 140 has satisfied the conditions for executing the slow deceleration control, the slow deceleration control is performed. In this case, in the host vehicle M, a longitudinal G is generated in slow deceleration. At this stage, the HMI 30 outputs a notification of the reason for the operation (only an image display including information indicating that the host vehicle M is approaching the different vehicle m1 in front). In the example in FIG. 9, the driver feels a longitudinal G due to slow deceleration with his/her body and recognizes the details of the notification output by the HMI 30, thereby recognizing the side in front of the host vehicle M (monitoring the surroundings) and making judgment for next action (driving operation).

At the time T13, the driver executes an AP operation of accelerating the host vehicle M while the slow deceleration control is being executed. At this time point, since an AP operation equal to or larger than a predetermined amount (predetermined value) is not executed, the braking override controller 142C judges not to execute the override control and continues the slow deceleration control. At this stage, a notification of the reason for the operation by the HMI 30 is also continuously output. Further, at the time T14 when the AP operation becomes equal to or larger than the predetermined amount, the braking override controller 142C judges that the conditions for executing the override control are satisfied and suspends the slow deceleration control by the slow deceleration controller 142A. Thereafter, since the host vehicle M accelerates in accordance with the opening degree of the accelerator due to driver's manual driving, a longitudinal G is generated due to the acceleration. Accordingly, the override control with respect to slow deceleration is executed.

In the example in FIG. 9, since the AP operation after the time T14 is constant, the host vehicle M accelerates to a speed corresponding to the AP operation after override, and the speed VM becomes a constant speed at the time point when it reaches a speed corresponding to the opening degree of the accelerator (time T15). After the override control is executed, a notification such as attention calling or an alarm from the HMI 30 also ends, and the slow deceleration control is not executed until the conditions for executing next slow deceleration are satisfied.

Here, the braking override controller 142C suspends the slow deceleration control when an AP operation equal to or larger than a predetermined amount is detected, but the predetermined amount (predetermined value) may be changed depending on the speed (AP operation speed) at which the driver performs an AP operation. For example, the braking override controller 142C sets a smaller predetermined amount when the AP operation speed of the driver is equal to or higher than a predetermined speed and sets a larger predetermined amount when the AP operation speed is lower than the predetermined speed. In this manner, the braking override controller 142C can make more appropriate override judgment with respect to the slow deceleration control by judging the driver's intention from the AP operation speed of the driver. The braking override controller 142C can make override judgment in a short period of time and can cope with the driver who quickly performs an AP operation by making override judgment when the AP opening degree change rate is equal to or higher than a predetermined value (3% to 5%). The braking override controller 142C makes override judgment when the amount of AP operation has increased by 10% to 20% or more (10% to 20%) based on the AP opening degree at the time of starting control, and therefore it is possible to make override judgment on the basis of the magnitude of the amount of operation even when override judgment cannot be made by an AP operation in a short period of time. Accordingly, it is possible to cope with the driver who slowly performs an AP operation.

### Steering Override

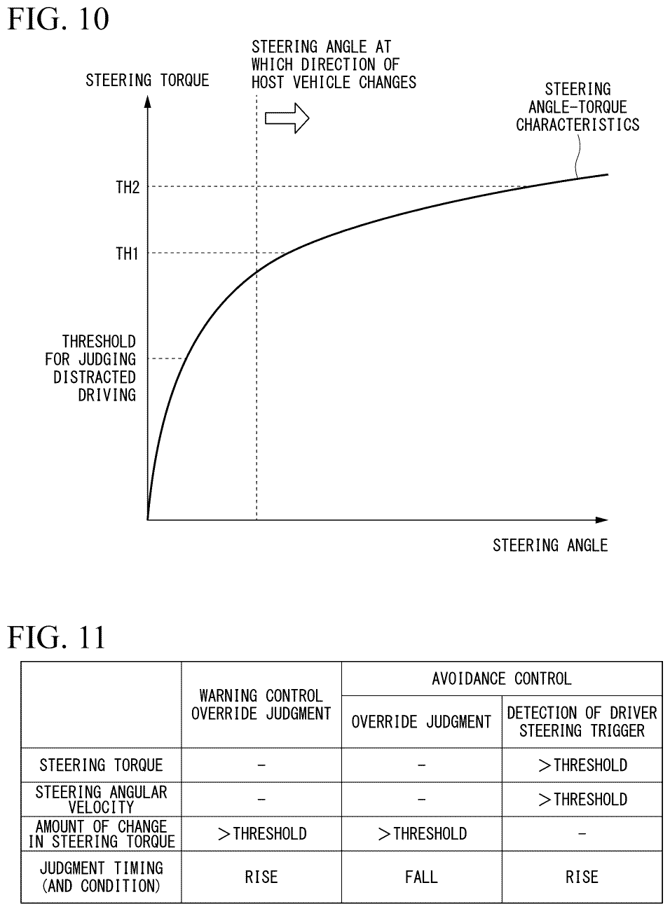

Next, details of steering override performed by the steering override controller 144C will be described using a diagram. FIG. 10 is an explanatory view of steering override. In FIG. 10, as an example, conditions for override judgment of the centering steering control at the time of the alarm control are described. FIG. 10 shows a relationship between the steering angle of the host vehicle M and torque characteristics of the steering wheel 82. The horizontal axis indicates the steering angle of the host vehicle M, and the vertical axis indicates the steering torque (torque amount) of the steering wheel 82. The example in FIG. 10 shows a threshold for judging whether or not distracted driving is being performed with respect to the steering torque (threshold for judging distracted driving), a judgment threshold TH1 (an example of a first threshold) for override of the avoidance control (automatic steering avoidance control and driver steering support control), and a judgment threshold TH2 (an example of a second threshold) for override of the LKAS control. For example, regarding the threshold for judging distracted driving, a steering torque smaller than that for a steering angle at which the direction of the host vehicle M changes (becomes a predetermined angle or larger) is adopted as a threshold. Accordingly, distracted driving can be judged even in a stable traveling state before the direction of the host vehicle M actually changes.

During the centering steering control, the steering override controller 144C executes the override control for suspending the steering control when the steering torque (amount of steering) of the driver is equal to or higher than the threshold. In this override judgment, the steering override controller 144C changes the judgment threshold depending on whether the steering direction of the steering torque of the driver is the forward direction or the opposite direction with respect to the steering control performed by the vehicle controller 140. The forward direction indicates the same direction as the steering direction in which the vehicle controller 140 (vehicle system) moves the host vehicle M in the lateral direction (road width direction), and the opposite direction is a direction opposite to the forward direction (for example, a direction opposite to the steering direction in which the vehicle controller 140 moves the host vehicle M in the lateral direction, a direction in which steering by the vehicle system is hindered). For example, in the case of the centering steering control, the forward direction is a steering direction in which the host vehicle M is moved to the center of the traveling lane, and the opposite direction is a steering direction in which it is moved to be away from the center of the traveling lane.

Specifically, for example, a smaller value is set for the judgment threshold (opposite direction threshold) in steering in the opposite direction than for the judgment threshold (forward direction threshold) in steering in the forward direction. For example, regarding the opposite direction threshold, a steering torque to the extent that the direction of the host vehicle M slightly changes is set as the threshold. Since the driver's intention against the steering control can be clearly ascertained through a steering operation in the opposite direction, appropriate override judgment can be made even with a small steering torque. For example, the opposite direction threshold is set to a value close to the judgment threshold TH1 (value with an error smaller than a predetermined value). Namely, the opposite direction threshold is set to a value closer to the judgment threshold TH1 than the judgment threshold TH2.

Meanwhile, the forward direction threshold is set to a value larger than the opposite direction threshold. Regarding a steering operation in the same direction as vehicle control, since there is also a probability that the driver's operation will be led by the system-side steering control, by increasing the forward direction threshold, it is possible to allow the override control to be performed in a state in which the driver's intention becomes clearer due to detection of a large steering torque. For example, the forward direction threshold is set to a value close to the judgment threshold TH2 (value with an error smaller than a predetermined value). Namely, the forward direction threshold is set to a value closer to the judgment threshold TH2 than the judgment threshold TH1. By setting a value close (a value equivalent) to the judgment threshold for override of other driving support (existing driving control) in this manner, it becomes easier for the driver to ascertain the amount of operation necessary for override, and therefore it is possible to perform an appropriate steering operation to switch to manual driving.

For example, the judgment thresholds described above (distracted operation judgment threshold, judgment thresholds TH1 and TH2, opposite direction threshold, forward direction threshold) may be variably set in accordance with the situation of the road (for example, a curve road, a straight road, or the like) where the host vehicle M is traveling or may be variably set in accordance with the vehicle type of the host vehicle M (steering characteristics for each vehicle type) or the like. The steering override controller 144C may make override judgment on the basis of the amount of change in steering torque (which will be described below) instead of the steering torque.

### Timing of Override Judgment in Warning Control and Avoidance Control

As described above, vehicle control in the vehicle controller 140 includes warning control (slow deceleration, centering steering control) and avoidance control (automatic steering avoidance control and the driver steering support control). However, the timing of judging override (timing of executing override) in each control may be varied on the basis of a driver's operation or the like.

FIG. 11 is an explanatory view of timings of judging override during vehicle control. The example in FIG. 11 shows judgment timings in warning control related to steering control (centering steering control) and judgment timings in avoidance control (automatic steering avoidance control, driver steering support control). The example in FIG. 11 also shows timings for detecting a driver steering trigger that is an operation condition for the driver steering support control. In the warning control and the avoidance control, when a condition determined in advance for each of the details of control (shown in FIG. 11) is satisfied among the steering torque, the steering angular velocity, and the amount of change in steering torque (an example of the amount of change in steering), the steering override controller 144C executes override judgment corresponding to the satisfied condition. The amount of change in steering torque is a value derived on the basis of the steering torque and the steering angular velocity. For example, when the steering angular velocity is 10 [deg/s] and the steering torque is 1.0 [Nm], an amount of change in torque corresponding to the foregoing numerical value is derived.

For example, as shown in FIG. 11, while having the amount of change in steering torque being equal to or larger than the threshold as a judgment condition, the steering override controller 144C performs the override control in the warning control at a timing when a rise in amount of change in steering torque is further detected and performs the override control of the avoidance control at a timing when a fall is detected. For example, a rise in amount of change in steering torque is a state in which the amount of change in steering torque is changing away from a reference value (reference position). For example, a fall in amount of change in steering torque is a state in which the amount of change in steering torque is changing in a manner of approximating (returning) to the reference value. For example, the reference value is a position where the steering angle (or the amount of change in steering torque) is zero or the position of the steering wheel 82 when no steering operation is being performed.

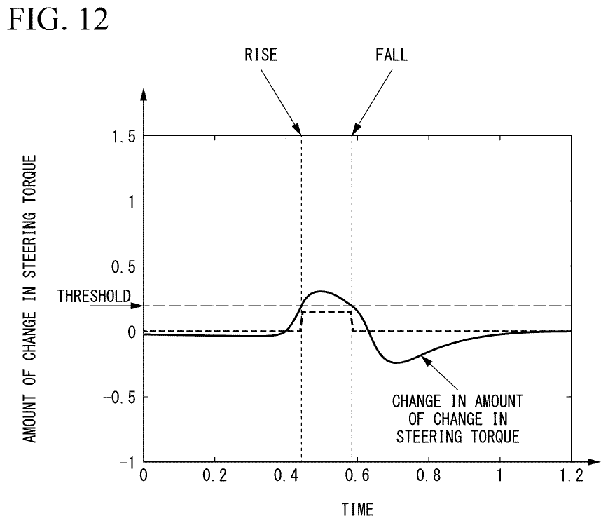

FIG. 12 is an explanatory view of rise and fall in amount of change in steering torque. In the example in FIG. 12, the horizontal axis indicates the time, and the vertical axis indicates the amount of change in steering torque at a predetermined time. When the amount of change in steering torque is 0 (zero), it is a state in which no driver's steering operation is being performed, and it indicates the reference value. For example, the steering override controller 144C detects a rise when the amount of change in steering torque becomes equal to or larger than the threshold in a direction away from the reference value and executes the override control of the warning control (centering steering control) being executed at this timing. A fall is detected when there is a change equal to or larger than the threshold in a returning direction to the reference value (direction in which it approximates to the reference amount of change) from a state of rise (state equal to or larger than the threshold) and executes the override control of the avoidance control (automatic steering avoidance control, driver steering support control) being executed at this timing. A fall may be judged based on whether or not the amount of change (amount of return to the reference value) from the largest value of the steering torque in a state of rise is equal to or larger than the threshold, or a fall may be detected when it returns to a value smaller than the threshold after the amount of change in steering torque has become equal to or larger than the threshold and a rise has been detected. A fall is not limited to the case in which there is a return of steering to the reference value. For example, since the amount of change in steering torque is derived on the basis of the steering torque and the steering angular velocity, the steering angular velocity decreases even in a state of being at a stop in a steered state so that there may be a fall.

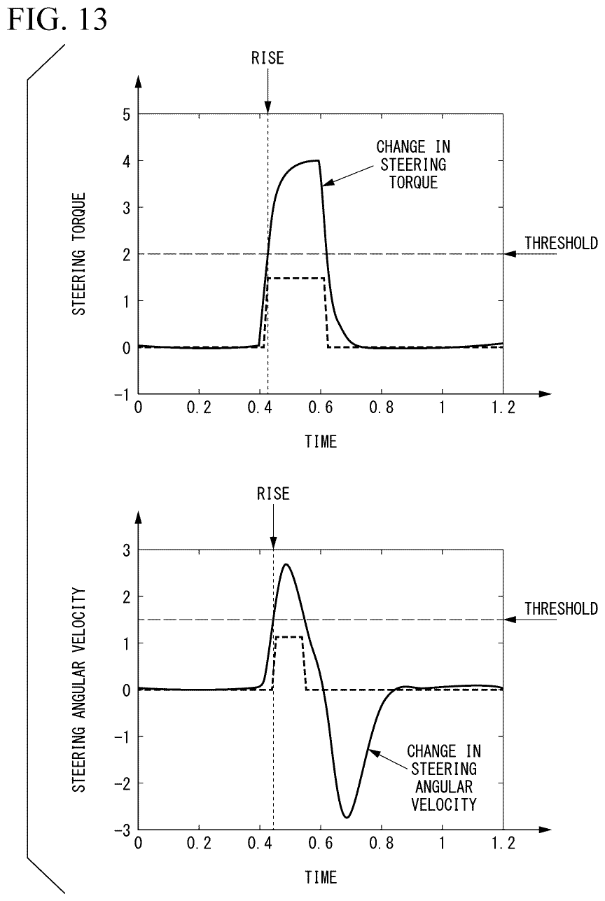

FIG. 13 is an explanatory view of timings of judging a driver steering trigger. In the example in FIG. 13, the horizontal axis indicates the time, and the vertical axis indicates the steering torque and the steering angular velocity, respectively. Since the driver steering support control is executed when the contact margin time TTC is short, it is better to detect a driver steering trigger immediately after a driver's steering operation has been detected. Therefore, in the case of a driver steering trigger, as shown in FIG. 13, a driver steering trigger is detected at the time of a rise of a steering operation (steering torque, steering angular velocity) reaching a value equal to or larger than the threshold in a short period of time.

The override control can be executed at a more appropriate timing by adjusting the judgment timing for each of the details (phases) of vehicle control as described above. For example, regarding the centering steering control, since the override control can be executed at a timing when a steering operation starts (rise timing), the warning control can be canceled (suspended) at an early timing. Regarding the avoidance control, since override judgment is made at the time of a fall, judgment can be made at a timing different from the timing of detecting a driver steering trigger (rise) which is one of the operation conditions for the driver steering support control, and therefore it is possible to curb a situation in which execution judgment of the driver steering support control and override judgment of the avoidance control are executed at the same timing so that various types of judgment can be made at more appropriate timings.

In the avoidance control, when it is first judged that there is a rise, the steering override controller 144C may make override judgment at the timing of a fall and then may make override judgment at the timing of a rise. At the first rise, since the timing of detecting a driver steering trigger during the automatic steering avoidance control and the timing of judging override are the same, priority is given to detection of a driver steering trigger at the first rise, and override judgment of the avoidance control is made at the time of the next fall. Further, regarding the override judgment thereafter (second and thereafter), since judgment of a driver steering trigger has already been made, override judgment may be executed at the timing of a rise.

### Processing Flow

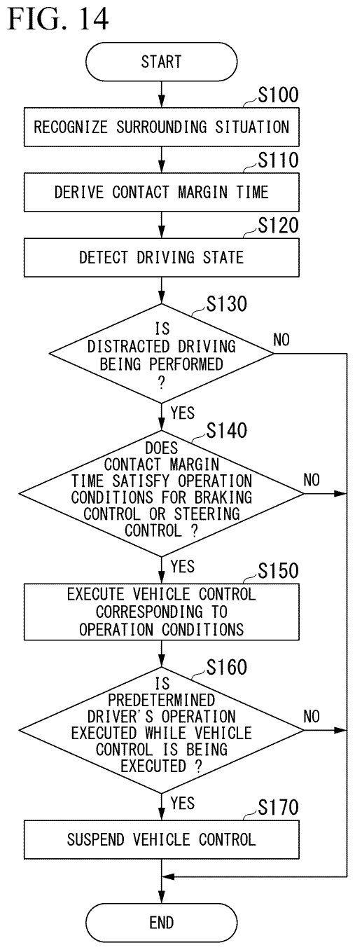

FIG. 14 is a flowchart showing an example of processing executed by the driving support device 100 according to the embodiment. In the example in FIG. 14, vehicle control processing including particularly the override control of the processing executed by the driving support device 100 is described.

In the example in FIG. 14, the recognizer 110 recognizes the surrounding situation of the host vehicle M (Step S100). Next, the contact probability judger 120 derives the contact margin time TTC between the host vehicle M and an obstacle on the basis of the recognized surrounding situation (Step S110). Next, the driving state detector 130 detects the driving state of the driver of the host vehicle M (Step S120) and judges whether or not the driver is performing distracted driving (Step S130). When it is judged that distracted driving is being performed, the vehicle controller 140 judges whether or not the contact margin time TTC satisfies operation conditions for the braking control or the steering control (Step S140). In the processing of Step S140, it may be judged whether or not the operation conditions for both the braking control and the steering control are satisfied. When it is judged that the contact margin time TTC satisfies the operation conditions for the braking control or the steering control, the vehicle controller 140 executes vehicle control corresponding to the operation conditions (Step S150). For example, this vehicle control includes at least one of the attention calling control, the contact attention alarm control, the automatic steering avoidance control, the driver steering support control, and the CMBS control described above.

Next, the vehicle controller 140 judges whether or not a predetermined driver's operation is executed while vehicle control is being executed (Step S160). When it is judged that the predetermined driver's operation is executed, the vehicle controller 140 suspends vehicle control being executed (Step S170). Accordingly, the processing of this flowchart ends. When it is judged that distracted driving is not performed in the processing of Step S130, when it is judged that the contact margin time TTC does not satisfy the operation conditions for the braking control or the steering control in the processing of Step S140, or when it is judged that the predetermined driver's operation is not executed while vehicle control is being executed in the processing of Step S160, the processing of this flowchart ends.

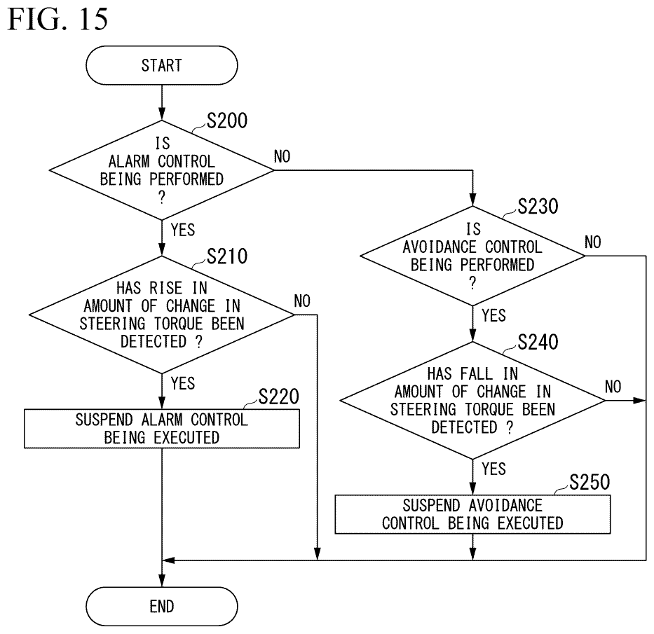

FIG. 15 is a flowchart showing an example of override judgment processing. The example in FIG. 15 shows an example of details executed in the processing of Steps S160 to S170 described above. The example in FIG. 15 shows override judgment processing related to a steering operation. In the example in FIG. 15, the steering override controller 144C judges whether or not the alarm control is being performed (Step S200). When it is judged that the alarm control is being performed, the steering override controller 144C judges whether or not a rise in amount of change in steering torque has been detected (Step S210). When it is judged that a rise in amount of change in steering torque (for example, a change equal to or larger than a predetermined amount from the reference value) has been detected, the steering override controller 144C suspends the alarm control being executed (Step S220).

In the processing of Step S200, when it is judged that the alarm control is not being performed, the steering override controller 144C judges whether or not the avoidance control is being performed (Step S230). When it is judged that the avoidance control is being performed, the steering override controller 144C judges whether or not a fall in amount of change in steering torque (for example, a change equal to or larger than the predetermined amount returning to the reference value) has been detected (Step S240). When it is judged that a fall has been detected, the steering override controller 144C suspends the avoidance control being executed (Step S250). Accordingly, the processing of this flowchart ends.

When it is judged that no rise in amount of change in steering torque has been detected in the processing of Step S210, when it is judged that the avoidance control is not being performed in the processing of Step S230, or when it is judged that no fall in amount of change in steering torque has detected in the processing of Step S240, this flowchart ends.

As described above, according to the embodiment, the driving support device 100 (an example of the vehicle control device) includes the recognizer 110 that recognizes the surrounding situation of the host vehicle M, the vehicle controller 140 that executes vehicle control for controlling at least one of acceleration/deceleration and steering of the host vehicle M when there is a probability of contact between the host vehicle M and an obstacle, and the driving state detector 130 that detects the driving state of an occupant of the host vehicle M. The vehicle control includes alarm control for notifying the occupant when the host vehicle M approaches an obstacle, and avoidance control for avoiding contact with an obstacle when the host vehicle M has approached further toward the obstacle from in the alarm control. The alarm control is suspended when a steering operation equal to or more than a predetermined amount from the reference value is detected due to a steering operation of the occupant detected by the driving state detector 130 during the alarm control, and the avoidance control is not suspended when a steering operation equal to or more than a predetermined amount from the reference value is detected during the avoidance control. Therefore, it is possible to make more appropriate override judgment in accordance with details of vehicle control being executed.

Specifically, according to the embodiment, in the steering avoidance control, override judgment of the alarm control (slow deceleration control, centering steering control) is judged based on a situation of an operation (rise) in the steering direction, and override judgment of the avoidance control is judged based on a situation of an operation (fall) in a returning direction from the steering direction, and therefore it is possible to curb unintended override control due to a driver's steering operation in the avoidance control related to the driver steering support control.

### Modification Example

In the embodiment described above, the slow deceleration control or the centering steering control in the attention calling control or contact attention alarm control is performed when it is judged that the driver is performing distracted driving as one of the operation conditions, but the slow deceleration control and the centering steering control may be selectively executed in accordance with whether or not the driver is performing distracted driving. For example, when it is judged that the driver is performing distracted driving, the vehicle controller 140 may perform the slow deceleration control and the centering steering control in the attention calling control and the contact attention alarm control, and when it is judged that distracted driving is not performed, any one of the slow deceleration control and the centering steering control may be performed. The vehicle controller 140 may execute the slow deceleration control when the centering steering control is not executed (for example, when traveling along the road division line) or when the host vehicle M moves in a direction in which it comes near the different vehicle m1 by performing the centering steering control. Moreover, since the centering steering control cannot be performed when the division lines of the traveling lane have not been able to be recognized, the vehicle controller 140 may perform the slow deceleration control. In the embodiment described above, the slow deceleration control or the centering steering control may be performed without judging whether or not the driver is performing distracted driving.

In the embodiment described above, an obstacle is not limited to a preceding vehicle and may be a different vehicle approaching the host vehicle M. An obstacle may be a pedestrian, a bicycle, or other objects (may not be a mobile object). Each of the numerical values indicated in the embodiment described above is merely an example and may be suitably adjusted in accordance with the road situation (shape, the number of lanes, road type), the driver's driving situation (distraction degree), the vehicle situation (speed, vehicle type, shape, the number of passengers), or the like.

The embodiment described above can be expressed as follows.

A vehicle control device includes a storage medium which stores computer-readable instructions, and a processor which is connected to the storage medium. The processor executes the computer-readable instructions to: recognize a surrounding situation of a vehicle; execute vehicle control for controlling at least one of acceleration/deceleration and steering of the vehicle when there is a probability of contact between the vehicle and an obstacle on the basis of recognized results; and detect a driving state of an occupant of the vehicle. The vehicle control includes alarm control for notifying the occupant when the vehicle approaches the obstacle, and avoidance control for avoiding contact with the obstacle when the vehicle has approached further toward the obstacle from in the alarm control. The alarm control is suspended when a steering operation equal to or more than a predetermined amount from a reference value is detected due to a steering operation of the occupant detected by the driving state detector during the alarm control. The avoidance control is not suspended when a steering operation equal to or more than a predetermined amount from the reference value is detected during the avoidance control.

Hereinabove, forms for performing the present invention have been described using an embodiment. However, the present invention is not limited to such an embodiment in any way, and various modifications and replacements can be added thereto within a range not departing from the gist of the present invention.

While a preferred embodiment of the invention has been described and illustrated above, it should be understood that these are exemplary of the invention and are not to be considered as limiting. 3. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a recognizer that recognizes a surrounding situation of a vehicle;
a vehicle controller that executes vehicle control for controlling at least one of acceleration/deceleration and steering of the vehicle when there is a probability of contact between the vehicle and an obstacle on the basis of recognition results of the recognizer; and
a driving state detector that detects a driving state of an occupant of the vehicle,
wherein the vehicle control includes alarm control for notifying the occupant when the vehicle approaches the obstacle, and avoidance control for avoiding contact with the obstacle when the vehicle has approached further toward the obstacle from in the alarm control, and
the vehicle controller
suspends the alarm control when a steering operation equal to or more than a predetermined amount from a reference value is detected due to a steering operation of the occupant detected by the driving state detector during the alarm control, and
does not suspend the avoidance control when a steering operation equal to or more than a predetermined amount from the reference value is detected during the avoidance control.

2. The vehicle control device according to claim 1,
wherein the vehicle controller suspends the avoidance control when a steering operation for the reference value is detected during the avoidance control.

3. The vehicle control device according to claim 1,
wherein the vehicle controller judges whether or not to suspend the avoidance control through a steering operation for returning to the reference value when a steering operation equal to or more than a predetermined amount from the reference value is first detected in the avoidance control.

4. The vehicle control device according to claim 1,
wherein the vehicle controller suspends the avoidance control when a steering operation for returning to the reference value is detected after a steering operation equal to or more than a predetermined amount from the reference value has been detected during the avoidance control.

5. The vehicle control device according to claim 1,
wherein the steering operation includes an operation based on an amount of change in steering derived by an amount of steering by the occupant and a steering angular velocity.

6. The vehicle control device according to claim 1,
wherein the alarm control includes steering control for moving the vehicle to a center of a traveling lane.

7. A vehicle control method in which a computer
recognizes a surrounding situation of a vehicle,
executes vehicle control for controlling at least one of acceleration/deceleration and steering of the vehicle when there is a probability of contact between the vehicle and an obstacle on the basis of recognized results, and
detects a driving state of an occupant of the vehicle,
wherein the vehicle control includes alarm control for notifying the occupant when the vehicle approaches the obstacle, and avoidance control for avoiding contact with the obstacle when the vehicle has approached further toward the obstacle from in the alarm control,
the alarm control is suspended when a steering operation equal to or more than a predetermined amount from a reference value is detected due to a steering operation of the occupant during the alarm control, and
the avoidance control is not suspended when a steering operation equal to or more than a predetermined amount from the reference value is detected during the avoidance control.

8. A computer readable non-transitory storage medium which stores a program causing a computer
to recognize a surrounding situation of a vehicle,
to execute vehicle control for controlling at least one of acceleration/deceleration and steering of the vehicle when there is a probability of contact between the vehicle and an obstacle on the basis of recognized results, and
to detect a driving state of an occupant of the vehicle,
wherein the vehicle control includes alarm control for notifying the occupant when the vehicle approaches the obstacle, and avoidance control for avoiding contact with the obstacle when the vehicle has approached further toward the obstacle from in the alarm control,
the alarm control is suspended when a steering operation equal to or more than a predetermined amount from a reference value is detected due to a steering operation of the occupant during the alarm control, and
the avoidance control is not suspended when a steering operation equal to or more than a predetermined amount from the reference value is detected during the avoidance control.
